(19) United States
(12) Patent Application Publication
(10) Pub. No.: US 2007/0160803 A1
(43) Pub. Date: Jul. 12, 2007

(54) Versatile exercise machine

(75) Inventor: Sherman Grider, Pomona, CA (US)

Correspondence Address: CISLO & THOMAS, LLP, 233 WILSHIRE BLVD, SUITE 900, SANTA MONICA, CA, 90401-1211, US

(73) Assignee: TuffStuff Fitness Equipment Inc.

(21) Appl. No.: 11/330,783

(22) Filed: Jan. 12, 2006

(51) Int. Cl. B32B 3/06

(52) U.S. Cl. 428/100; 428/99

(57) ABSTRACT

An exercise machine comprising a unique cam coupled to a unique, multi-faceted hinge construction located between the distal portions of a yoke and the extension arms of the exercise machine. The cam functions to prevent loss of resistance through the range of motion of the exercises permitted by the exercise machine. The multi-faceted hinge comprises a swivel portion that allows the extension arms of said exercise machine to pivot on a horizontal plane such that the user may perform a pectoral fly exercise or a lateral raise exercise. The multi-faceted hinge further comprises a hinge bracket that allows the extension arms of said exercise machine to pivot in a vertical plane such that the user may perform an overhead shoulder press exercise. The multi-faceted hinge further comprises one or more fastening members that allow the extension arms to rotate along their long axis such that the user can adopt differing hand grips for variation in the exercises mentioned herein. By means of the hinge construction and cam design described herein, a user may perform a unique variety of exercises without the need for attaching or removing parts from an exercise machine, and without the loss of resistance through the range of motion of the exercises performed with the exercise machine.

### BACKGROUND OF THE INVENTION

This invention relates to exercise machines and more particularly to a versatile exercise machine in which a number of distinct exercise movements can be performed on the same machine without having to attach or remove additional hardware elements, and without a loss of resistance through the range of motion of the distinct exercise movements performed.

Over the past several years, people have become more interested in maintaining good physical health by deliberately engaging in exercise and other physical activities. Weightlifting is but one of the many types of exercise that people choose in order to maintain fitness. Swimming, running, rowing, aerobic activity, as well as other forms of exercise are also used in order to maintain fitness and provide some aerobic challenge to a person's system so that they may maintain better health. The link between physical activity and physical health is well recognized.

Weight lifting is often a preferred form of physical activity because particular muscle groups, which may have importance for specific sports or the like, can be targeted and developed. Consequently, through weight lifting, an individual can focus actively on his or her biceps, triceps, calves, thighs, gluteals, abdominals, etc. In so doing, an individual may not only engage in aerobic activity, but activity that specifically strengthens a chosen muscle or group of muscles.

There are a significant number of exercise machines available that allow the user to target particular muscles of the upper body, including the pectorals, biceps, triceps, shoulders, latissimus dorsi, and other back muscles. There even exist combination machines that allow for the user to exercise more than one muscle group, as shown, for example in prior art reference U.S. Pat. No. 6,234,941 to Chu. Nevertheless, the machine described in Chu is very limited in the scope of exercises available to the user.

It would be advantageous to provide a versatile exercise machine that allows for a wide variety of exercises to be accomplished by the user without the need to attach or remove parts from the machine, and without the loss of resistance through the range of motion of the exercises.

### SUMMARY OF THE INVENTION

The present invention is an exercise machine that comprises a unique hinge construction between the distal, or top, portions of a yoke and the extension arms, which terminate in handles. The support frame, seat, cables, pulleys, and weight stack associated with the present exercise machine are well known in the art. The multi-directional hinge, however, is a unique element of the present invention.

The multi-directional hinge of the present invention comprises a swivel means that includes a swivel connected to the top portion of each side of the yoke, thus allowing the extension arms to pivot, or rotate, on a horizontal plane in line with the direction of the swivel. This pivotability allows the user of the exercise machine to perform a pectoral fly exercise, and facilitates a lateral raise exercise.

The multi-directional hinge of the present invention further comprises a vertical pivot means that includes a hinge bracket pivotably attached to each of the swivels such that the extension arms may pivot along a vertical plane. This vertical pivotability allows the user of the machine to perform an overhead shoulder press exercise. This vertical pivotability is not mutually exclusive of the horizontal pivotability provided by the swivel, and the combination of the two allows the user of the machine to perform exercises at alternative angles, if desired. For example, a lateral raise exercise would require the use of the swivels to rotate the extension arms outward relative to the machine, and the vertical pivot means would allow the user to move his or her arms up and down at a lateral position.

The multi-directional hinge of the present invention further comprises one or more fastening members that simultaneously connect the extension arms to the hinge brackets, but allow the extension arms to be rotated along their long axis such that the user can adopt differing hand grips for variation in the exercises mentioned herein.

An additional unique feature of the present invention is the construction of the cam, which is shaped similarly to an apostrophe, comma, or paisley and its side channel, or groove, forms an elongated, elliptical arc rather than being substantially circular in shape, giving this cam design the advantage of preventing resistance loss through the range of motion permitted by the present invention.

### OBJECTS OF THE INVENTION

It is an object of the present invention to provide a versatile exercise machine wherein a user can engage in a variety of exercise movements on the same machine.

It is a further object of the present invention to provide a versatile exercise machine wherein a user can engage in a variety of exercise movements on the same machine without having to attach or remove parts of the machine.

It is a further object of the present invention to provide a unique hinge element wherein the arms of an exercise machine are capable of pivoting in horizontal and vertical directions wherein a user can engage in a variety of exercise movements on the same machine.

It is a further object of the present invention to provide a unique hinge element wherein the arms of an exercise machine are capable of pivoting in horizontal and vertical directions wherein a user can engage in a variety of exercise movements on the same machine without having to attach or remove parts of the machine.

It is a further object of the present invention to provide a unique hinge element construction wherein the top portion of the yoke of the exercise machine comprises a horizontal swivel upon which a hinge pivotable along a vertical plane is affixed.

It is a further object of the present invention to provide a novel cam design that allows the user of the exercise machine described herein to perform the exercises facilitated by the unique hinge element described herein without a loss of resistance through the range of motion of the respective exercises permitted by the exercise machine.

These and other objects and advantages of the present invention will be apparent from a review of the following specification and accompanying drawings.

### BRIEF DESCRIPTION OF THE DRAWINGS

FIG. 1 is a back perspective view of the front portion of the claimed exercise machine.

FIG. 2 is a top plan view of the front portion of the claimed exercise machine.

FIG. 3 is a front elevational view of the front portion of the claimed exercise machine.

FIG. 4 is a perspective view of the top portion of the yoke of the claimed exercise machine where said yoke connects to the arm of the claimed exercise machine.

FIG. 5 is a front perspective of the claimed exercise machine.

FIG. 6 is a front elevational view of the claimed exercise machine.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions may be accomplished by different embodiments that are also intended to be encompassed within the spirit and scope of the invention.

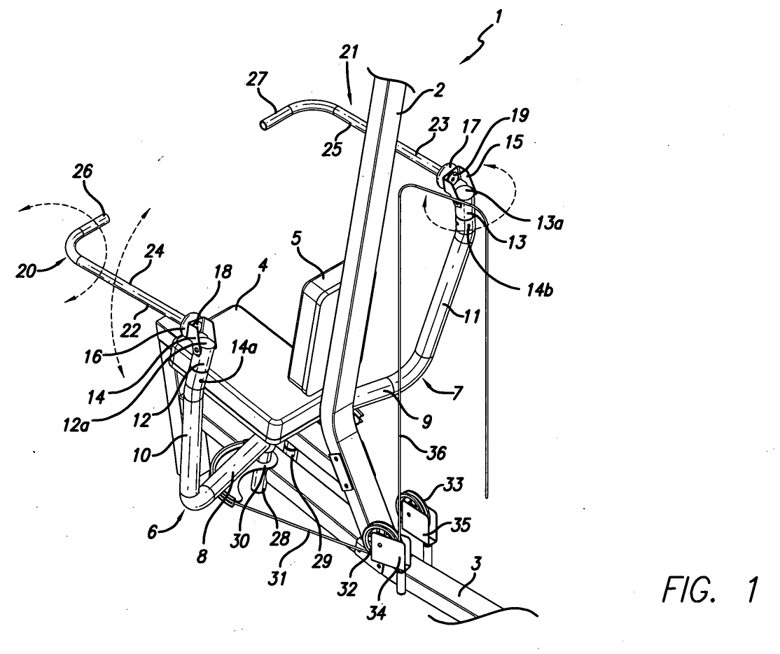

The exercise machine 1 described herein is one of great versatility. A user of the machine is capable of performing a number of exercises, including a lateral raise exercise for the deltoids, a pectoral fly exercise for the pectoral muscles, a bench press for the pectoral muscles, and a vertical overhead press exercise for the shoulders, without attaching or removing parts of the machine. In addition, these exercises can be performed at variable angles, where desirable, because of the unique pivotability of the extension arms 20, 21 of the exercise machine 1, which are capable of pivoting in a vertical plane, rotating in a horizontal plane about swivels 12, 13, and rotating about its long axis, as shown by the broken arrows in FIG. 1. For convenience, a structure will often be identified herein by two reference numbers with the understanding that many of the parts of the machine have parallel structures on the left and right side of the machine.

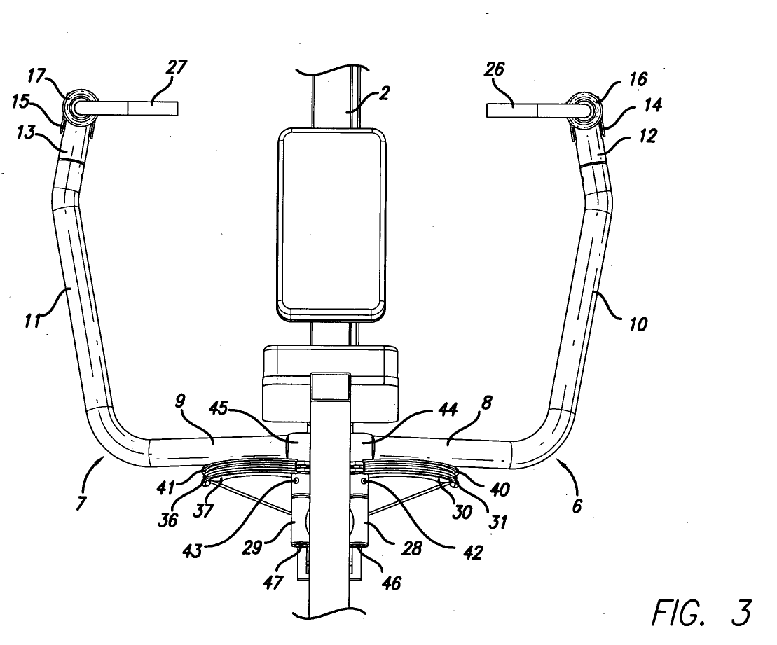

FIGS. 1 and 3 depict the front portion of an exercise machine 1 that contains front vertical support frame element 2 and front horizontal frame support element 3 as is well-known in the art, as well as a seat pad 4 and a back pad 5 to provide comfort for the user while operating the machine. Below seat 4 and adjacent to the side edges of front horizontal frame support element 3 are two yoke pivoting means, each comprised of a yoke receiving element 44, 45 and a vertical attachment shaft 28, 29 operatively connected to a cam 30, 37, said cam 30, 37 containing a side channel, or groove, 40, 41 along a portion of the cam perimeter that serves to guide cable 31, 36 from the yoke pivoting means to the weight stack (not shown) via a system of pulleys 32, 33 (other pulleys not shown) at least partially housed within pulley brackets 33, 34.

Cam 30, 37 possesses a novel design in that it is shaped (as shown in FIGS. 1, 5, and 6) somewhat as an apostrophe, comma, or paisley and its side channel, or groove, 40, 41 forms an elongated, elliptical arc rather than being substantially circular in shape. One advantage of cam 30, 37 over the prior art is that, unlike similar exercise machines in the prior art, cam 30, 37 prevents the loss of resistance through the range of motion of the exercises facilitated by the present invention. In the prior art, the resistance towards the end of the range of motion is approximately 60% less than that at the beginning of the range of motion. In the present invention, cam 30, 37 functions to maintain a relatively constant resistance through the first approximately 30% of the range of motion, and then the resistance gradually increases over the remainder of the range of motion. It is the elongated, elliptical side channel, or groove, 40, 41 that provides cam 30, 37 with its functional properties.

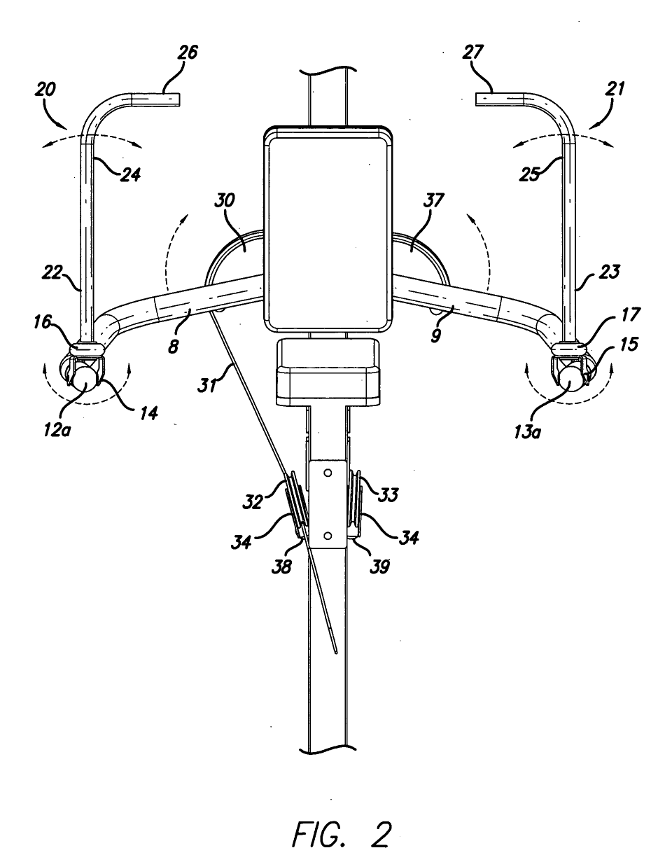

The yoke pivoting means referenced above functions to rotate the left and right yokes 6, 7 about the vertical attachment shafts 28, 29 along a substantially horizontal plane, and the pulleys 32, 33, together with their respective pulley brackets 34, 35, are capable of swiveling on pulley swivels 38, 39 (see FIG. 2 at reference number 32), said pulley swivels 38, 39 being operatively connected to the left and right sides of front horizontal support frame element 3 located proximally to the junction of front vertical support frame element 2 and front horizontal support frame element 3. Vertical attachment shafts 28, 29 are operatively connected to front horizontal support frame element 3 by molding, welding, or other similar means known in the field of invention.

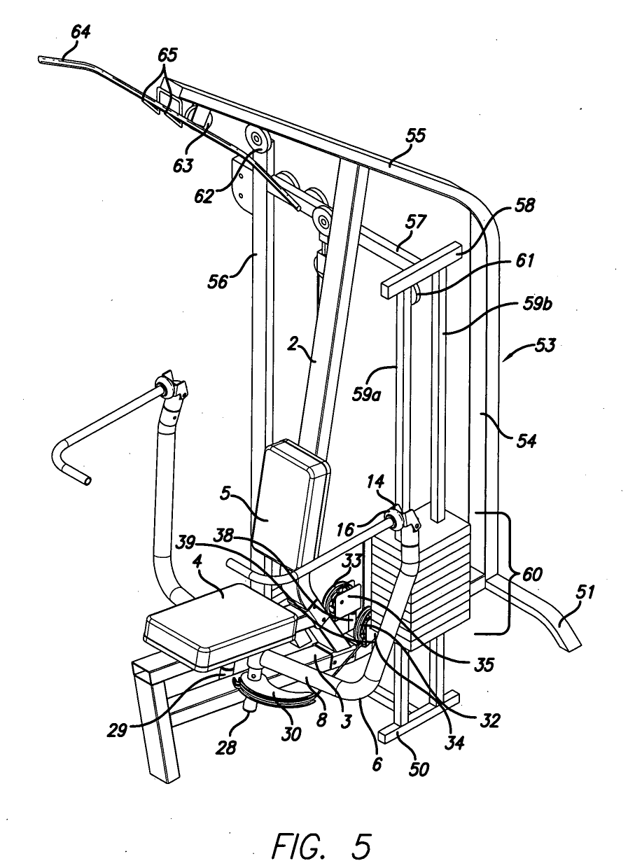

Cam 30, 37 is eccentrically impaled by, and operatively connected to, vertical attachment shafts 28 and 29 at a location below yoke receiving elements 44, 45, as shown, for example, in FIG. 5. Yoke receiving elements 44, 45 each comprise a blind bore that is substantially cylindrical in cross-sectional shape and of sufficient diameter to receive the left and right horizontal yoke portions 8, 9, which are also substantially cylindrical in cross-section and of lesser diameter than the yoke receiving elements 44, 45. It should be noted that the entirety of the left and right yokes 6, 7 and extension arms 20, 21 are substantially cylindrical in cross-sectional shape.

FIGS. 1 and 3 also depict the construction of the yokes and extension arms on the exercise machine. Left and right horizontal yoke portions 8, 9 extend horizontally in a lateral direction from the vertical attachment shafts 28, 29 and yoke receiving elements 44, 45 underneath seat pad 4 to a position lateral to, but approximately even with, or slightly below, in elevation to, seat pad 4. At this lateral position along yokes 6, 7, the left and right horizontal yoke portions 8, 9 curve in a generally vertical direction and become left and right vertical yoke portions 10, 11, which elevate to a height approximately equal to the top of back pad 5. The top portion 12, 13 of left and right vertical yoke portions 10, 11 may taper slightly inwardly towards back pad 5. It should also be stated that the height of seat pad 4 may be adjustable as is well-known in the art.

The top portion 12, 13 of left and right vertical yoke portions 10, 11 is substantially the same in cross-sectional shape and diameter as left and right vertical yoke portions 10, 11, and comprises a swivel means constituting a swivel operatively connected to and comprising the top portion 12, 13 of left and right vertical yoke portions 10, 11, said swivel means allowing extension arms 20, 21 to rotate on a horizontal plane either away from, or towards, the user (as shown by the dashed arrows around the top portion 13 of right vertical yoke portion 11, thus allowing for a pectoral fly exercise or a lateral raise exercise. Said swivels are affixed to the top portion 12, 13 of left and right vertical yoke portions 10, 11 by a universal joint or related structure as known in the art that allows one structure to swivel about a second fixed element.

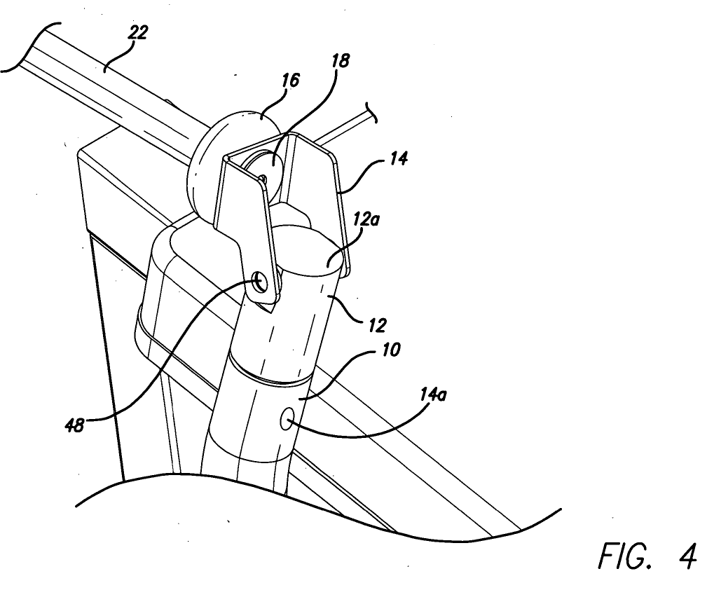

Shown in FIG. 1, but particularly in FIG. 4, is a vertical pivot means comprising hinge brackets 14, 15 pivotably attached through hole 48 (and an analogous hole on the opposite side hinge bracket) to the side of top portion 12, 13 of left and right vertical yoke portions 10, 11, which allows the attached extension arms 20, 21 to pivot along a substantially vertical plane. This pivoting movement of extension arms 20, 21 allows the user to perform an overhead press exercise, and also facilitates the performance of a lateral raise exercise when used in conjunction with the swivel means.

Hinge brackets 14, 15 each contain a hole (not shown) on a face perpendicular to the portion of the hinge bracket 14 containing hole 48, or hinge bracket 15 containing the analogous hole, through which the proximal ends 22, 23 of extension arms 20, 21 pass and are secured in place by fastening members 18, 19 fastened to the inner portion of hinge brackets 14, 15 and fastening donuts 16, 17 on the outer portion of hinge brackets 14, 15.

It should be noted, however, that extension arms 20, 21 are fastened to hinge brackets 14, 15 in a manner so as to allow extension arms 20, 21 to rotate about their long axis extending from the proximal ends 22, 23 to the distal ends 24, 25 of extension arms 20, 21. This third aspect of the unique pivotability of extension arms 20, 21 allows the user to vary the position of the handles 26, 27 so as to adopt differing handgrips for various exercises, which in turn offers variation in how a particular muscle group is worked by a particular exercise.

FIG. 2 (as shown by the dashed arrows from the left and right horizontal yoke portions 8, 9) shows at least some of the potential movements that can be accomplished by a user of exercise machine 1. First, with the machine in the position as shown in the top plan view of FIG. 2, a user can grasp the handles 26, 27 and extend his or her arms forward to move left and right horizontal yoke portions 8, 9 forward, and effectuate a chest or bench press exercise movement. The user may also rotate extension arms 20, 21 to perform a chest press exercise at a different hand angle (see dashed arrows adjacent to reference numbers 24 and 25).

FIG. 2 (as shown by the dashed arrows about the top surfaces 12a, 13a of the yokes) also shows that extension arms 20, 21 are capable of swiveling, or rotating on a horizontal plane so that the user can effectuate a pectoral fly movement by grasping handles 26, 27 and pulling extension arms 20, 21 inwardly toward the seat area.

Although not specifically shown in FIG. 2, extension arms 20, 21 pivot in a vertical plane by hinge brackets 14, 15, and when a user grasps handles 26, 27 and pushes them upwards, an overhead shoulder press exercise is effectuated.

FIG. 5 shows exercise machine 1 in its entirety, including frame support elements 50, 51, 53, 54, 55, 56, 57, 58, 59a, 59b. The arrangement of the various frame support elements 50, 51, 53, 54, 55, 56, 57, 58, 59a, 59b, pulleys 61, 62 (others not shown), and weight stack 60 adheres to conventions generally well known in the art, though the details of such construction may vary between exercise devices, and will not be described in extensive detail herein. It is understood that the connectivity of the various frame support members may be by welding, bolting, or other standard means, unless otherwise indicated.

Lower horizontal-floor element 50 is a substantially T-shaped metallic bar that rests on the floor. A first axis of lower horizontal floor element 50 receives the lower ends of weight stack retaining elements 59a, 59b, which are tubular elements oriented in a vertical direction and upon which weight stack 60 is positioned. Under force from pulley 61, weight stack 60 slides up and down weight stack retaining elements 59a, 59b as the user operates the machine in its various capacities and exerts force upon cables 31, 36, which transfer the force to pulley 61. A second axis of lower horizontal floor element 50 runs perpendicular to the first axis of lower horizontal floor element 50 and terminates approximately underneath front horizontal frame support element 3. An additional lower frame support element 52 substantially similar in “front-to-back” location as lower, horizontal floor element 50 relative to exercise machine 1 is elevated slightly from the ground, contacting the ground at its distal ends. Affixed to additional lower frame support element 52 closer to the periphery of exercise machine 1 is vertical frame element 56.

As shown in FIG. 5 as substantially parallel to lower horizontal frame element 50 is upper horizontal frame element 58, which comprises relatively thick metal and is substantially T-shaped. The shorter axis of upper horizontal floor element 58 and receives the upper ends of weight stack retaining elements 59a, 59b opposite the ends received by the shorter axis of lower horizontal floor element 50. The portion of the longer axis of upper horizontal floor element 58 mist distal to weight stack retaining elements 59a, 59b is affixed to vertical frame element 56.

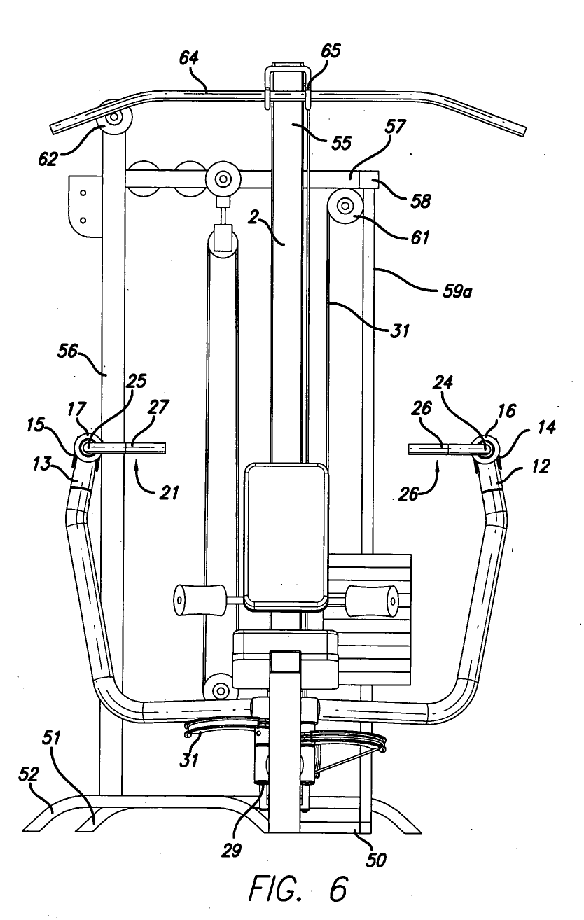

Rear lower horizontal support frame element 51 is a generally flat, rectangular, and relatively thick, horizontally disposed metallic strip at the rear of exercise machine 1 wherein the extreme lateral portions of the metallic strip curve in a downward direction and the ends of the metallic strip contact the floor. FIG. 5 shows the right hand portion of rear lower horizontal support frame element 51, and FIG. 6 shows the left hand portion of rear horizontal support frame element 51. Affixed to the central portion of rear lower horizontal support frame element 51 is rear frame element 53, which is comprised of a vertical portion 54 rising from the central portion of rear lower horizontal support frame element 51, and a generally horizontal portion 55 that, at an elevation approximately equivalent to upper horizontal frame element 58, curves towards the front of exercise machine 1 in a slightly vertical orientation relative to the floor, remaining substantially perpendicular to rear lower horizontal frame element 51.

As shown in FIGS. 5 and 6, in a preferred embodiment of exercise machine 1, a grasping element such as bar 64, or other similar grasping devices typically used for weight training, can be operatively connected to the forward end of the generally horizontal portion 55 of rear frame member 53 by a cable terminating in a closable or similar structure, and pulley 63. Bar 64, or other similar grasping elements, allow the user to perform exercises on the triceps or latissimus dorsi muscle groups by directing a downward force upon pulley 63 and a cable (not shown), which then transfers the force to weight stack 60 by well known means. When overhead bar 64 is not in use, it can be laid to rest on grasping element support member 65, which consists of two fork-like projections. It is understood that the design of grasping element support member 65 may be varied to accommodate grasping elements other than a bar.

The foregoing description of the frame support elements and pulleys represent feature of the present invention that are well known in the art.

While the present invention has been described with regards to particular embodiments, it is recognized that additional variations of the present invention may be devised without departing from the inventive concept.

What is claimed is:

1. An exercise machine comprising:
a support frame comprising a plurality of operatively interconnected support frame elements;
a seat operatively connected to said support frame;
left and right yokes;
a yoke pivoting means operatively mounted below said seat for pivotal movement of said left and right yokes;
one or more cams operatively connected to said yoke pivoting means, each said cam(s) containing a perimeter groove to guide a cable from said yoke pivoting means to a weight stack via one or more pulleys, whereby said cam(s) prevent a loss of resistance through the range of motion of the respective exercises of said exercise machine;
left and right extension arms each pivotably connected to the upper portion of said left and right yokes by a swivel means and a vertical pivot means, said left and right extension arms being pivotable along a substantially horizontal plane and a substantially vertical plane;
a handle portion comprising the distal end of said left and right extension arms;
wherein said exercise machine can be engaged by said user to perform under weight resistance a variety of movements at a variety of angles for the pectoral muscles, deltoids, and shoulder muscles without the need to attach or remove any parts from the machine to engage in the various available movements.

2. An exercise machine as claimed in claim 1, wherein said left and right extension arms are rotatable along their long axis, said handle portion being articulable to different positions to allow for variable hand-gripping by a user of said exercise machine;

3. An exercise machine as claimed in claim 1, wherein said yoke pivoting means comprises at least one yoke receiving element functionally connected to at least one vertical attachment shaft.

4. An exercise machine as claimed in claim 2, wherein said yoke pivoting means comprises at least one yoke receiving element functionally connected to at least one vertical attachment shaft.

5. An exercise machine as claimed in claim 1, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

6. An exercise machine as claimed in claim 2, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

7. An exercise machine as claimed in claim 3, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

8. An exercise machine as claimed in claim 1, wherein said seat comprises a seat pad and a back pad, one or both of which are adjustable to the height and physique of the user.

9. An exercise machine as claimed in claim 5, wherein said seat comprises a seat pad and a back pad, one or both of which are adjustable to the height and physique of the user.

10. An exercise machine comprising:
a support frame comprising a plurality of operatively interconnected support frame elements;
a seat operatively connected to said support frame;
left and right yokes;
a yoke pivoting means operatively mounted below said seat for pivotal movement of said left and right yokes;
one or more cams operatively connected to said yoke pivoting means, each said cam(s) containing a perimeter groove to guide-a cable from said yoke pivoting means to a weight stack via one or more pulleys, whereby said cam(s) prevent a loss of resistance through the range of motion of the respective exercises of said exercise machine;
left and right extension arms each pivotably connected to the upper portions of said left and right yokes by a swivel means and a vertical pivot means, said left and right extension arms being pivotable along a substantially horizontal plane and a substantially vertical plane;
a handle portion comprising the distal end of said left and right extension arms;
said left and right extension arms being rotatable along their long axis, said handle portion being articulable to different positions to allow for variable hand-gripping by a user of said exercise machine;
wherein said exercise machine can be engaged by said user to perform under weight resistance a variety of movements at a variety of angles for the pectoral muscles, deltoids, and shoulder muscles without the need to attach or remove any parts from the machine to engage in the various available movements.

11. An exercise machine as claimed in claim 10, wherein said left and right extension arms are rotatable along their long axis, said handle portion being articulable to different positions to allow for variable hand-gripping by a user of said exercise machine;

12. An exercise machine as claimed in claim 1, wherein said yoke pivoting means comprises at least one yoke receiving element functionally connected to at least one vertical attachment shaft.

13. An exercise machine as claimed in claim 11, wherein said yoke pivoting means comprises at least one yoke receiving element functionally connected to at least one vertical attachment shaft.

14. An exercise machine as claimed in claim 10, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

15. An exercise machine as claimed in claim 11, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

16. An exercise machine as claimed in claim 12, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

17. An exercise machine as claimed in claim 10, wherein said seat comprises a seat pad and a back pad, one or both of which are adjustable to the height and physique of the user.

18. An exercise machine as claimed in claim 14, wherein said seat comprises a seat pad and a back pad, one or both of which are adjustable to the height and physique of the user.

19. An exercise machine comprising:
a support frame comprising a plurality of operatively interconnected support frame elements;
a seat operatively connected to said support frame;
left and right yokes;
a yoke pivoting means operatively mounted below said seat for pivotal movement of said left and right yokes;
one or more cams operatively connected to said yoke pivoting means, each said cam(s) containing a perimeter groove to guide a cable from said yoke pivoting means to a weight stack via one or more pulleys, whereby said cam(s) prevent a loss of resistance through the range of motion of the respective exercises of said exercise machine;
left and right extension arms each pivotably connected to the upper portions of said left and right yokes by a swivel means and a vertical pivot means, said left and right extension arms being pivotable along a substantially horizontal plane and a substantially vertical plane;
a handle portion comprising the distal end of said left and right extension arms;
wherein said exercise machine can be engaged by said user to perform under weight resistance a variety of movements at a variety of angles for the pectoral muscles, deltoids, and shoulder muscles.

20. An exercise machine as claimed in claim 19, wherein said left and right extension arms are rotatable along their long axis, said handle portion being articulable to different positions to allow for variable hand-gripping by a user of said exercise machine;

21. An exercise machine as claimed in claim 19, wherein said yoke pivoting means comprises at least one yoke receiving element functionally connected to at least one vertical attachment shaft.

22. An exercise machine as claimed in claim 20, wherein said yoke pivoting means comprises at least one yoke receiving element functionally connected to at least one vertical attachment shaft.

23. An exercise machine as claimed in claim 19, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

24. An exercise machine as claimed in claim 20, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

25. An exercise machine as claimed in claim 21, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

26. An exercise machine as claimed in claim 19, wherein said seat comprises a seat pad and a back pad, one or both of which are adjustable to the height and physique of the user.

27. An exercise machine as claimed in claim 23, wherein said seat comprises a seat pad and a back pad, one or both of which are adjustable to the height and physique of the user.

28. An exercise machine comprising:
a support frame comprising a plurality of operatively interconnected support frame elements;
a seat operatively connected to said support frame;
left and right yokes;
a yoke pivoting means operatively mounted below said seat for pivotal movement of said left and right yokes;
one or more cams connected to said yoke pivoting means, each said cam(s) containing a perimeter groove to guide a cable from said yoke pivoting means to a weight stack via one or more pulleys, whereby said cam(s) prevent a loss of resistance through the range of motion of the respective exercises of said exercise machine;
left and right extension arms each pivotably connected to the upper portions of said left and right yokes by a swivel means and a vertical pivot means, said left and right extension arms being pivotable along a substantially horizontal plane and a substantially vertical plane;
a handle portion comprising the distal end of said left and right extension arms;
said left and right extension arms being rotatable along their long axis, said handle portion being articulable to different positions to allow for variable hand-gripping by a user of said exercise machine;
wherein said exercise machine can be engaged by said user to perform under weight resistance a variety of movements at a variety of angles for the pectoral muscles, deltoids, and shoulder muscles.

29. An exercise machine as claimed in claim 28, wherein said left and right extension arms are rotatable along their long axis, said handle portion being articulable to different positions to allow for variable hand-gripping by a user of said exercise machine;

30. An exercise machine as claimed in claim 28, wherein said yoke pivoting means comprises at least one yoke receiving element functionally connected to at least one vertical attachment shaft.

31. An exercise machine as claimed in claim 29, wherein said yoke pivoting means comprises at least one yoke receiving element functionally connected to at least one vertical attachment shaft.

32. An exercise machine as claimed in claim 28, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

33. An exercise machine as claimed in claim 29, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

34. An exercise machine as claimed in claim 30, wherein said support frame comprises a generally horizontal element at an upper portion of said support frame to which a grasping element is functionally connected to the forward end of said generally horizontal portion and to said weight stack via a cable and one or more pulleys such that said user can perform exercises for the triceps or latissimus dorsi muscle groups.

35. An exercise machine as claimed in claim 28, wherein said seat comprises a seat pad and a back pad, one or both of which are adjustable to the height and physique of the user.

36. An exercise machine as claimed in claim 32, wherein said seat comprises a seat pad and a back pad, one or both of which are adjustable to the height and physique of the user.

37. A hinge for use in between a yoke and extension arms of an exercise machine, comprising:
a swivel means and a vertical pivot means, said extension arms being pivotable along a substantially horizontal plane and a substantially vertical plane;
wherein said exercise machine comprises a plurality of operatively interconnected support frame elements, a seat operatively connected to said support frame, said yoke, said extension arms terminating in a handle portion, and a system of at least one cable and at least one pulley functionally connecting said yoke to a weight stack via said swivel means and said vertical pivot means; and,
said hinge allowing a user to perform under weight resistance a variety of movements at a variety of angles for the pectoral muscles, deltoids, and shoulder muscles.

38. A hinge for use in between a yoke and the extension arms of an exercise machine as claimed in claim 37, wherein said swivel means comprises a swivel pivotably connected to a top portion of each side of said yoke, and said vertical pivot means comprising a hinge bracket pivotably connected to each of said swivels.

39. A hinge for use in between a yoke and the extension arms of an exercise machine as claimed in claim 37, wherein said extension arms terminating in a handle portion are pivotably connected to said vertical pivot means by one or more fastening elements, said extension arms terminating in a handle portion being rotatable along their long axis, said handle portion being articulable to different positions to allow for variable hand-gripping by a user of said exercise machine.

40. A hinge for use in between a yoke and the extension arms of an exercise machine as claimed in claim 38, wherein said extension arms terminating in a handle portion are pivotably connected to said hinge bracket by one or more fastening elements, said extension arms terminating in a handle portion being rotatable along their long axis, said handle portion being articulable to different positions to allow for variable hand-gripping by a user of said exercise machine.
